(19) United States
(12) Patent Application Publication
(10) Pub. No.: US 2015/0100667 A1
(43) Pub. Date: Apr. 9, 2015

(54) OPTIMIZING CONTENT DELIVERY

(71) Applicant: WePow, Inc., Sunnyvale, CA (US)

(72) Inventors: Andres Freyria, Guadalajara (MX); Jaime S. Romero, Guadalajara (MX)

(73) Assignee: WePow, Inc., Sunnyvale, CA (US)

(21) Appl. No.: 14/048,687

(22) Filed: Oct. 8, 2013

(51) Int. Cl. H04L 29/08

(52) U.S. Cl. CPC H04L 67/02
USPC 709/219

(57) ABSTRACT

Computer-implemented systems and methods for optimizing content delivery is disclosed herein. Client attribute data is received for a selected client computing device, including a selected client encoding format. A server hint is received, the server hint indicating that the selected client computing device is likely to access a first media file. A first edge server computer of the content delivery network receives the first media file in a first encoding format. At least one cost value associated with propagating the first media file in the content delivery network is calculated based on the client attribute data. The content delivery network determines whether to make the first media file available in the selected encoding format on a selected edge server computer of the content delivery network based on the at least one cost value.

### TECHNICAL FIELD

The present disclosure generally relates to content delivery systems. The disclosure relates more specifically to techniques for performing transcoding of media items for different computing platforms with which the media items may be played.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Content delivery networks are used to provide content over a network or internetworks, such as the Internet. A content delivery network is a system of servers configured to deliver the content to end-users requesting the content. Content delivery networks may have independent infrastructure from an associated application server that the end-users interact with when requesting the content. The content may include media items that are requested or provided in file different formats, such as encoding formats. Furthermore, the content may be requested or provided in different resolutions.

To ensure availability and accessibility of content, content may be duplicated across the servers of a content delivery network. When different formats and/or resolutions are used, multiple versions of the content are duplicated across the servers. For example, a particular media item may be received at one server and then immediately transcoded into multiple different formats, such as Flash, MPEG-4, and others that are compatible with various player software for different computing platforms such as PCs, APPLE IOS devices, and ANDROID devices; in many cases, the transcoding is performed for multiple different transmission bitrates for streaming files of each format. When the content delivery network is distributed over a wide geographic area, then multiple different media files for the same content may need to be stored on multiple different geographically separated server computers to that a copy of the content is near a particular player device at the time that the device requests to play the content.

The availability of a specific version of the content on multiple servers increases performance in delivering the specific version to multiple end-users requesting the content. The increased performance is obtained by generating the multiple versions of the content, transmitting the multiple versions of the content to multiple servers, and storing the multiple versions of the content on the multiple servers. However, the complexity of such a system is high. For example, large amounts of storage resources are needed to hold the multiple files in different formats and bitrates. In addition, large amounts of CPU or processing resources are needed to transcode one media item into a large number of different formats, bitrates and/or distributed storage locations. When a particular media item is played relatively rarely, these resources are largely wasted.

### SUMMARY OF THE INVENTION

The appended claims may serve as a summary of the invention.

### BRIEF DESCRIPTION OF THE DRAWINGS

In the drawings:

FIG. 1 illustrates an overview of an embodiment of a system for optimizing content delivery;

FIG. 2 illustrates data flow in an embodiment of a system for optimizing content delivery;

FIG. 3 illustrates an embodiment of client attribute data;

FIG. 4 illustrates an embodiment of a method for processing a server hint to optimize content delivery;

FIG. 5 illustrates an embodiment of a method for delivering a resource comprising a media file stored in a content delivery network;

FIG. 6 illustrates an embodiment of a method for processing a second media file received from a client in response to viewing a first media file;

FIG. 7 illustrates a computer system upon which an embodiment may be implemented.

### DESCRIPTION OF EXAMPLE EMBODIMENTS

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

1. General Overview

Computer-implemented systems and methods are provided for optimizing delivery of content embodied in media files. Media files are stored in a content delivery network. The content delivery network includes edge server computers configured to provide the media files to end-users in different encoding formats. The content delivery network determines whether to propagate a specific version of a specific media file to a specific edge server computer based on additional data. The content delivery network is optimized to balance delivery performance of the media file against the costs of propagating the media file across the edge server computers.

In an embodiment, client attribute data is received for a selected client computing device. The client attribute data includes a selected client encoding format. A server hint is received. The server hint indicates that the selected client computing device is likely to access a first media file. A first edge server computer of the content delivery network receives the first media file in a first encoding format. At least one cost value associated with propagating the first media file in the content delivery network is calculated based on the client attribute data. The content delivery network determines whether to make the first media file available in the selected encoding format on a selected edge server computer of the content delivery network based on the at least one cost value.

Embodiments provide distinct technical benefits, in terms of performance and reduced storage, for environments in which a large number of media items are used by each media item is played a relatively small number of times, and played only with a small number of devices or perhaps one kind of device. For these environments, embodiments provide the benefit of greatly reduced storage and greatly reduced use of computing resources, without sacrificing performance when the media item is played by the target or expected type of computing device.

2. System Overview

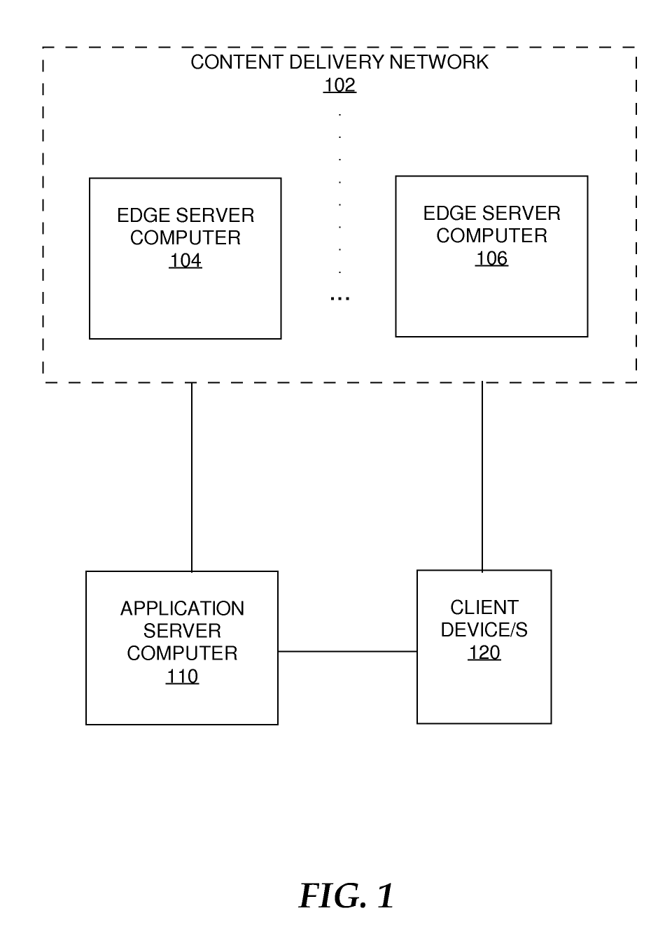

FIG. 1 illustrates an overview of an embodiment of a system for optimizing content delivery. Content delivery network 102 is a network of a plurality of computers configured to store and deliver content, such as one or more media files. For example, the media files may include image files, audio files, video files, multimedia files, and/or any other type of media file. In one embodiment, the media files include streaming content. Content delivery network 102 further comprises a plurality of edge server computers 104, 106. Edge server computers 104, 106 include any computer in content delivery network 102 configured to provide content to one or more client devices 120 over a network, such as the Internet.

In addition to edge server computers 104, 106, content delivery network 102 may further include additional computers configured to manage content delivery and storage between edge server computers 104, 106. Alternatively and/or in addition, edge server computers 104, 106 may be configured to manage one or more transactions between edge server computers 104, 106.

Client devices 120 may include one or more computing devices configured to access content from content delivery network 102, such as computers, laptops, netbooks, ultrabooks, cellular devices, smartphones, PDAs, or any other computing device configurable to access content from content delivery network 102.

Content delivery network 102 may be further configured to receive content from one or more of client devices 120. For example, an edge server computer 104, 106 may be configured to receive content from a client device 120. Alternatively and/or in addition, a client device 120 may be configured to submit content to content delivery network 102 via an application server computer 110. In one embodiment, content delivery network 102 is configured to provide a first media file to a client device 120, and receive a second media file generated by the client device 120 after the first media file is displayed on the client device 120.

As used herein, when data is transmitted to, received by, transmitted from, or provided by a content delivery network, such as content delivery network 102, any component of the content delivery network, including any of edge server computers 104, 106, it may perform the associated action. Furthermore, any action performed by a content delivery network, such as content delivery network 102, may be performed by a component of the content delivery network.

Application server computer 110 includes one or more computers configured to provide one or more resources and/or services to clients devices 120. In one embodiment, application server computer 110 is configured to provide one or more resources to client devices 120. In one embodiment, a resource provided by application server computer 110 includes a first resource portion and a media file portion. The media file portion is stored in content delivery network 102, while the first resource portion includes portions of the resource not stored in the content delivery network 102. In one embodiment, the first resource portion includes non-media file resources that are directly provided by application server computer 110. In this case, application server computer 110 is configured to provide the first resource portion to client devices 120, and content delivery network 102 is configured to provide the media file portion to client devices 120. Application server computer 110 is configured to allow client devices 120 to publish and view media files. In one embodiment, application server computer 110 is configured to implement a dating system, a professional development system, an interviewing system, or any other type of networking system.

3. File Format and Propagation

Client computing devices may be configured to view and/or generate media files in a specific format, such as a specific encoding format. The specific encoding format associated with a client computing device may be determined based on one or more applications running on the client computing device, and operating system of the client computing device, or other factors. In one embodiment, a client computing device may be compatible with multiple specific encoding formats. In this case, a media file may be submitted to a content delivery network in a first format, and requested from the content delivery network in a second format.

To make a specific file available on a specific edge server computer in a specific format, the specific file must be transcoded to the specific format and transmitted to the specific edge server computer. Propagating the specific media file in the content delivery network incurs costs, such as licensing fees, computing resources, transfer time, network resources, storage resources, or any other cost associated with propagating the specific media file in the content delivery network.

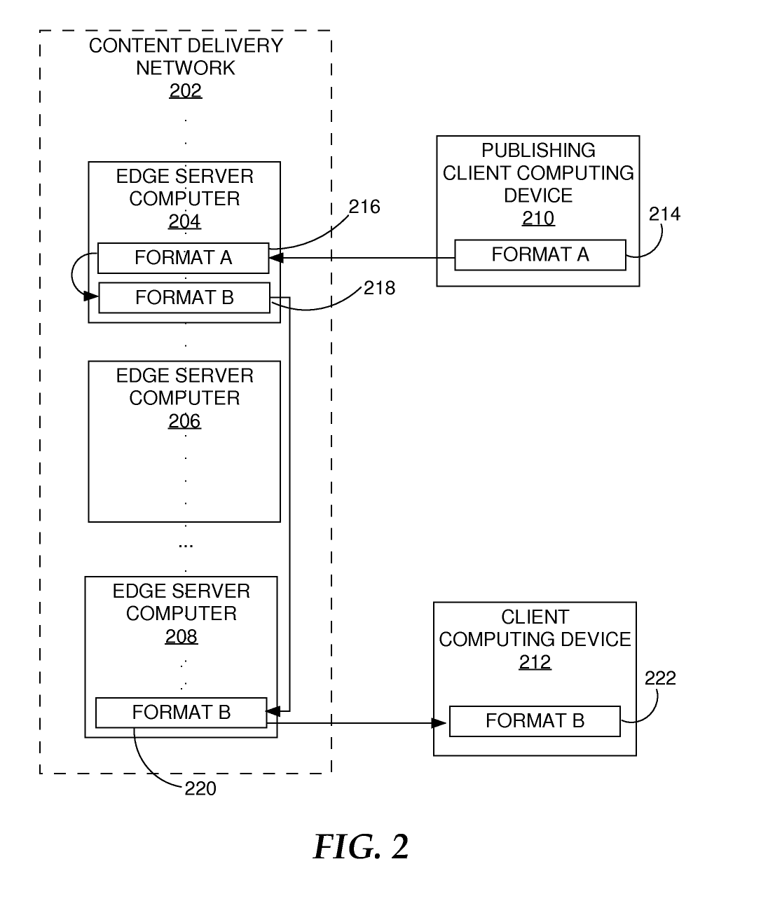

FIG. 2 illustrates data flow in an embodiment of a system for optimizing content delivery. Content delivery network 202 includes edge server computers 204-208. Publishing client computing device 210 is a publisher of a media file. An original instance 214 of the media file is initially generated by publishing client computing device 210 in Format A. The original instance 214 is provided, over a network, to the edge server computer 204. In one embodiment, edge server computer 204 stores the media file in instance 216 in Format A.

Content delivery network 202 may be configured to propagate the received instance 216 from edge server computer 204 to one or more other edge server computers. In one embodiment, content delivery network 202 determines whether to make the media file available in a specific encoding format on a specific edge server computer of content delivery network 202 by processing a server hint. The server hint includes information that indicates that one or more client computing devices are likely to access the media file. In one embodiment, the server hint is received by content delivery network 202 from an application server computer. The application server computer may generate the server hint based on client attribute data. In one embodiment, the server hint is based on an interaction between client computing device 212 and the application server computer.

For example, content delivery network 202 may process a server hint associated with client computing device 212 and determine that the media file should be available on edge server computer 208 in Format B. In this case, instance 216 is converted to Format B. In one embodiment, edge server computer 204 converts the media file from Format A to Format B, and transmits the media file to edge server computer 208. Additionally or alternatively, the media file may be converted at edge server computer 208 after transmitting the media file in Format A. in one embodiment, format A and format B are encoding formats, and the media file is converted using one or more transcoding processes.

An instance 220 of the media file is stored on edge server computer 208 in Format B. If it is determined that the media file should be available on edge server computer 204 in Format B, instance 218 is stored on edge server computer 204. For example, the determination may be made based on one or more cost value calculations. In one embodiment, a media file may be transmitted for storage on another edge server computer in the same format, such as when a server hint indicates that a client computing device is likely to access the media file on a different edge server computer in the same format.

4. Server Hints

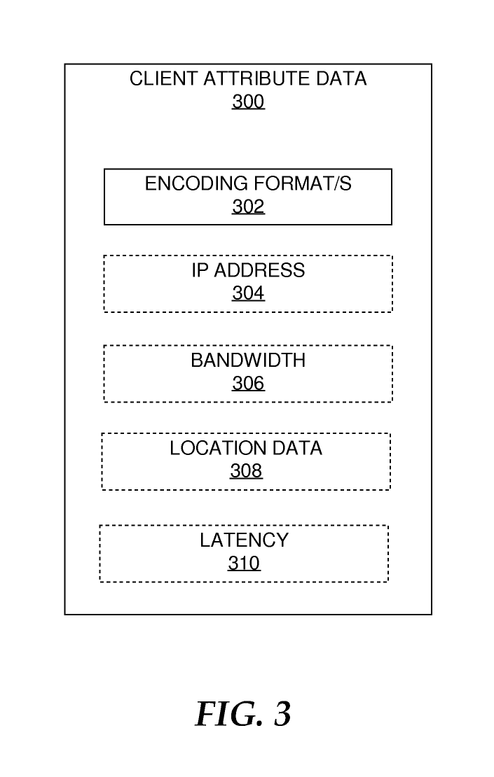

Server hints include information that indicates that one or more client computing devices are likely to access the media file. A server hint is based on client attribute data for one or more client computing devices, such as client attribute data described in FIG. 3. The server hint includes one or more selected encoding formats compatible with the one or more client computing devices. Specifically, a selected client computing device is configured to display the media file in the selected encoding format. The media file is obtained from the content delivery network in the selected encoding format. The selected encoding format may be based on one or more applications and/or operating systems associated with the selected client computing device.

In one embodiment, portions of a server hint may be transmitted to the content delivery network separately. For example, client attribute data, such as an encoding format associated with a specific client computer, may be transmitted in a separate communication from potential access information associated with the specific client computer.

In one embodiment, a client computing device interacts with an application server computer that provides the client computing device with at least a portion of a resource that contains a media file. The client computing device may obtain a portion of the resource from the application server computer, and may obtain the media file from the content delivery network.

Server hints may include any information indicating that one or more client computing devices are likely to access the media file in a specific format from the content delivery network. For example, server hints may be generated based on:

accessing, by a specific client computing device, a notification regarding a media file;

device hardware information for the specific client computing device;

network metric information for the specific client computing device;

network metric information between the specific client computing device and one or more components of the content delivery network;

application information and/or operating system information for the specific client computing device;

demographic information for an individual and/or entity user of the specific client computing device;

prior usage patterns and other usage information for one or more individual users, groups of users and/or demographic;

other potential access information regarding a demographic that includes a user of one or more client computing devices;

connecting, by the specific client computing device, to the application server computer;

other context or actions performed by one or more users;

predefined policies associated with one or more individual users, groups of users and/or demographic;

In addition, server hints may be generated based on any other data that indicates that one or more client computing devices is likely to access the media file in a specific format from the content delivery network.

As shown in the examples above, a server hint may be related to a specific client computing device, but may also be related to a demographic/grouping that includes one or more specific computing devices. As used herein, the term “demographic” refers to any characteristic of members of the group that may be used to select a subset of the members from the group. The members of the group may be persons, associations, corporations, other business entities, or any other entity.

In one embodiment, data stored on the content delivery network includes media files for which a low number of accesses is expected. In one embodiment, no server hint is generated for at least a portion of media files made available in the content delivery network, such as one or more media files published by client computing device/s. In one embodiment, an application server computing determines not to provide a server hint to the content delivery network for a specific media file. In this case, the media file may be received by an edge server computer in an initial encoding format, but is not propagated in the content delivery network, in either the initial encoding format or another encoding format.

After receiving a server hint, the content delivery network determines whether to make the media file available in a specific encoding format on a specific edge server computer. The content delivery network calculates and evaluates the cost of making the media file available on a specific edge server computer in advance of an actual request from a client computing device. The costs may be associated with transmitting, storing and/or transcoding media file data, such as licensing fees, computing resources, transfer time within the content delivery network computers, transfer time between an edge server computer and the selected client computing device, network resources, storage resources, or any other cost associated with propagating the media file in the content delivery network. The cost may also be associated with delivery performance of the media file from the content delivery network to the client computing device.

5. Client Attribute Data

Client attribute data for one or more client computing devices is used to generate server hints. FIG. 3 is a block diagram that illustrates an embodiment of client attribute data. Client attribute data 300 includes one or more encoding formats 302. Encoding format/s 302 identify one or more media file formats that the associated client computing devices configured to display. In one embodiment, the media file includes streaming video data. An encoding format associated with a specific client computing device may be based on one or more applications and/or operating systems of the client computing device, device hardware information for the specific client computing device, network metrics associated with a specific computing device, and/or any other factor that would affect an encoding format.

Client attribute data 300 may include one or more network metrics, such as an IP address data 304, bandwidth data 306, location data 308, and latency data 310. Network metrics may be obtained by an application server computer, such as when a connection is initiated between the client computing device and the application server computer. Network metrics may also include information on the connection between the client computing device and one or more components of the content delivery network, such as one or more edge servers.

Bandwidth data 306 may be used to determine an appropriate bit rate for the media file to improve delivery performance of the media file from the content delivery network. Location data 308 and latency data 310 may be used by the content delivery network and/or the application data server to determine one or more potential edge server computers of the content delivery network. Location data 308 may be calculated and/or estimated by GPS, IP address data 304, network data, or any other method for determining the location of a computing device coupled to a network. Latency data 310 may include latency data between the client computing device and one or more edge server computers of the content delivery networks, and may be calculated and/or estimated by DNS latency resolution data, ping operations, or any other suitable method for obtaining latency data between computing devices on a network.

In one embodiment, the encoding format includes bit rate information for the media file. Depending on the encoding format, computing resources, storage resources and/or other factors, a content delivery network may provide a media file at multiple bit rates by storing multiple copies of the media file encoded using a specific encoding format and the specific bit rate, and/or by processing a media file to modify the bit rate when the media file is accessed.

6. Cost Calculation

After receiving a server hint, the content delivery network makes one or more decisions based on calculated cost values. Cost values include actual and/or estimated costs of making the media file available on a specific edge server computer in advance of an actual request from a client computing device. The costs may be associated with transmitting, storing and/or transcoding media file data, such as licensing fees, computing resources, transfer time within the content delivery network computers, transfer time between an edge server computer and the selected client computing device, network resources, storage resources, or any other cost associated with propagating the media file in the content delivery network. The cost may also be associated with delivery performance of the media file from the content delivery network to the client computing device.

One or more cost values may be associated with the cost of transcoding media data, transferring media data and/or storing media data. The cost may also include fees, such as licensing fees for software and/or encoding formats. In one embodiment, unitary costs are assigned for computing resources, such as bandwidth, storage, processor time, and/or any other computing resources. For example, calculations may be based on one or more of the following relationships and/or combinations thereof:

Encoding cost˜processor time*processor time's unitary cost;

Encoding cost˜licensing fees;

Transfer cost˜bandwidth*bandwidth's unitary cost;

Storage cost˜media file size*storage's unitary cost.

Cost value calculations may also be based on any other relationship defined with respect to propagating media data in the content delivery network.

In one embodiment, a File Availability Operation (FAO) cost is determined for a potential action of making a media file available on a specific edge server in a specific encoding format. For example, the FAO cost may be a sum of all costs associated with making a media file available on a specific edge server computer in a specific encoding format. In the case where the media file is already available on the specific edge server in the specific encoding format, the FAO cost is zero.

In one embodiment, a FAO efficiency is calculated for a potential action. The FAO efficiency is based on an improvement in delivery performance with respect to the FAO cost. The improvement delivery performance may be based on timeliness, quality, latency, and other factors related to improved delivery performance to an end-user. In one embodiment, the content delivery network is configured to perform one or more potential actions based on FAO efficiency. For example, potential actions above an FAO efficiency threshold may be performed. Alternatively and/or in addition, potential actions may be performed in an order based on FAO efficiency.

7. Propagation Based on a Server Hint

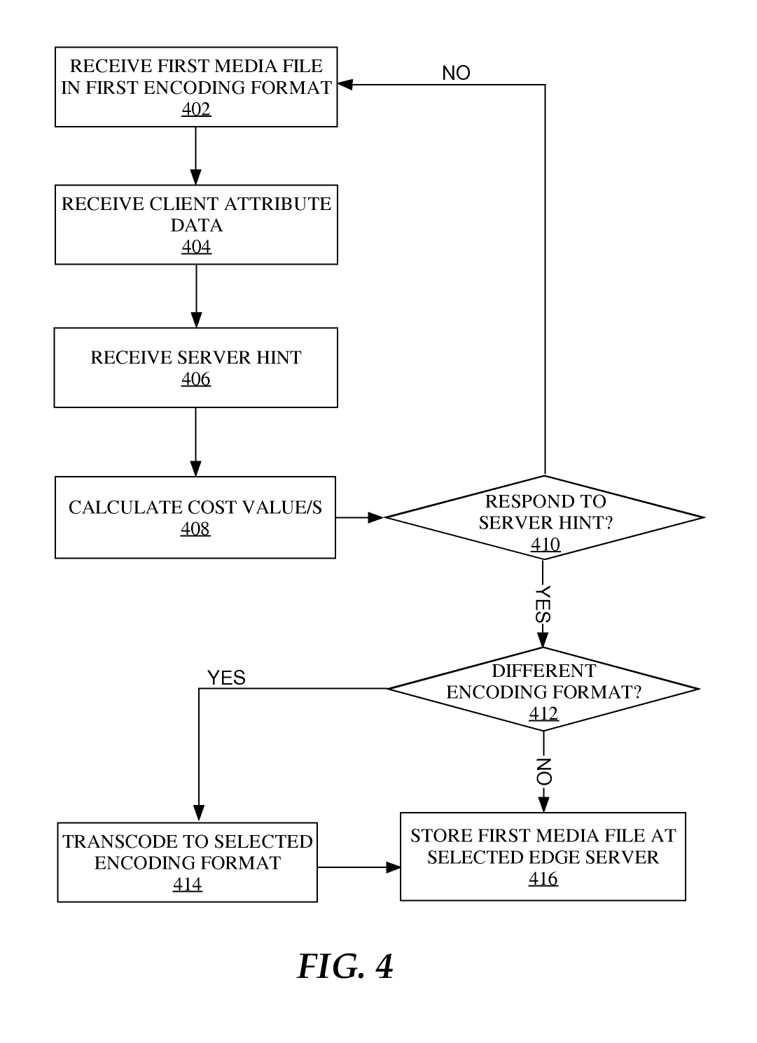

FIG. 4 is a flow diagram that illustrates an embodiment of a method for processing a server hint to optimize content delivery.

At block 402, a first media file is received in a first encoding format. The first media file is received by a first edge server computer of the content delivery network. In one embodiment, the first media file is received from an application server computer. Alternatively and/or in addition, the first media file may be received from a publishing client computing device.

At block 404, client attribute data is received for a selected computing device. The client attribute data includes a selected encoding format associated with the selected computing device. The client attribute data may further include at least one network metric associated with the client computing device. In one embodiment, the client attribute data is received by an application server computer, such as when the computing device establishes a connection with the application server computer.

At block 406, a server hint is received. The server hint is received by a content delivery network comprising a plurality of edge server computers. The server hint indicates that the selected client computing device is likely to access the first media file on the client delivery network. In one embodiment, the server hint identifies multiples client computing devices likely to access the first media file. The content delivery network may receive the server hint from an application server computer. The application server computer may generate the server hint based on the client attribute data. In one embodiment, the server hint is based on an interaction between the selected client computing device and the application server computer.

At block 408, at least one cost value is calculated. The at least one cost value is associated with propagating the first media file in the content delivery network. Cost values are calculated based on the client attribute data. For example, one or more cost values may be associated with transcoding the first media file to the selected encoding format associated with the selected computing device, transmitting the first media file to one or more edge server computers, storing the first media file at one or more edge server computers, or other factors related to propagation of the first media file. In one embodiment, the client attribute data includes one or more network metrics associated with the selected client computing device, and one or more calculated cost values are associated with delivery performance.

The cost values correspond to actual and/or estimated licensing fees, computing resources, transfer time within the content delivery network computers, transfer time between an edge server computer and the selected client computing device, network resources, storage resources, or any other cost associated with propagating the first media file in the content delivery network.

At decision block 410, it is determined whether to respond to the server hint based on the at least one cost value. In one embodiment, it is determined whether to transmit the first media file to a selected edge server computer of the content delivery network based on the at least one cost value. The selected edge server computer may be selected based on one or more network metrics associated with the selected client computing device. For example, the selected edge server computer may be selected based on latency, IP address, geographical location, time until file availability, and/or any other factor related to delivery performance between an edge server computer and the client computing device. In one embodiment, the content delivery network may determine to transmit the first media file to multiple selected edge server computers. If it is determined that the first media file will be transmitted, processing continues to decision block 412. Otherwise, processing returns and/or terminates. For example, if the first media file will not be transmitted, processing may continue to processing a successive media file, passing control to a calling process, sending a notification, returning after a method or function invocation, or terminating.

At decision block 412, it is determined whether the selected encoding format is different from the first encoding format. If the encoding formats are different, processing continues to block 414. Otherwise, processing continues to block 416.

At block 414, the first media file is transcoded from the first encoding format to the selected encoding format. In one embodiment, the first media file is transcoded by the first edge server computer before transmitting the first media file to the selected edge server computer. Alternatively, the first media file may be transmitted to the selected edge server computer before transcoding. In one embodiment, the content delivery network is configured to determine a component of the content delivery network to transcode the first media file based on one or more cost values.

At block 416, the first media file is stored in the selected encoding format by the selected edge server computer.

8. Accessing Content

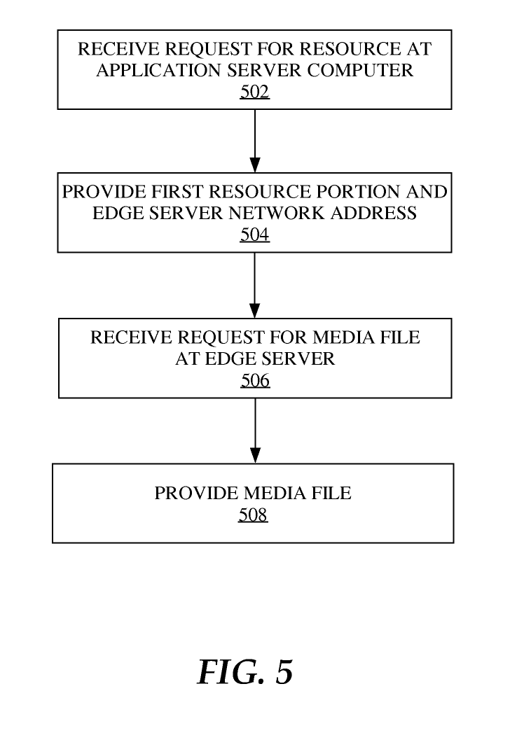

FIG. 5 is a flow diagram that illustrates an embodiment of a method for delivering a resource comprising a media file stored in a content delivery network. In one embodiment, the method is performed after a server hint corresponding to the media file is processed, such as by the method shown in FIG. 4.

At block 502, a request for a resource is received at an application server computer. The request is received from a client computing device. The resource includes a first resource portion and a media file portion. The media file portion is stored in the content delivery network. The first resource portion includes portions of the resource not stored in the content delivery network, and may include resources that are directly provided to the client computing device by the application server computer. In one embodiment, the request for the resource is received after the application server computer provides a server hint to the content delivery network. In one embodiment, the client computing device is configured to receive and display the media file in a specific encoding format. The client computing device may be configured to receive and display the media file in multiple compatible encoding formats.

At block 504, the first resource portion is provided to the client computing device by the application server computer. The application server computer further provides at least one network address where the media file may be accessed in the specific encoding format/s. In one embodiment, the network address or addresses are associated with one or more edge server computers storing the media file, in the selected encoding format, at the time the media request is received, such as one or more edge server computers storing the media file after a server hint has been processed. The network address or addresses may also be associated with one or more edge server computers to which transmission of the first media file is scheduled, such as after a server hint has been processed.

In one embodiment, the network address is associated with an edge server computer initially storing the media file in an initial format. In one embodiment, the network address is associated with an edge server initially storing the media file when the content delivery network did not respond to a server hint, when no server hint was received by the content delivery network, or when a scheduled transmission of the first media file (in response to processing a server hint) is not complete.

At block 506, a media request for the media file is received from the client computing device. The media request is received by a specific edge server computer. The request is based on the network address provided to the client computing device by the application server computer. In one embodiment, the media request is received while propagation to the specific edge server computer is in progress, scheduled, or completed.

At block 508, the media file is provided to the client computing device by the specific edge server computer receiving the media request. The media file is provided in a selected encoding format that is compatible with the client computing device. In one embodiment, the media file is provided in a streaming format. When the media file is provided in a streaming format, transmission of the first media file to the specific edge server computer may be in progress.

9. Processing Media File Responses

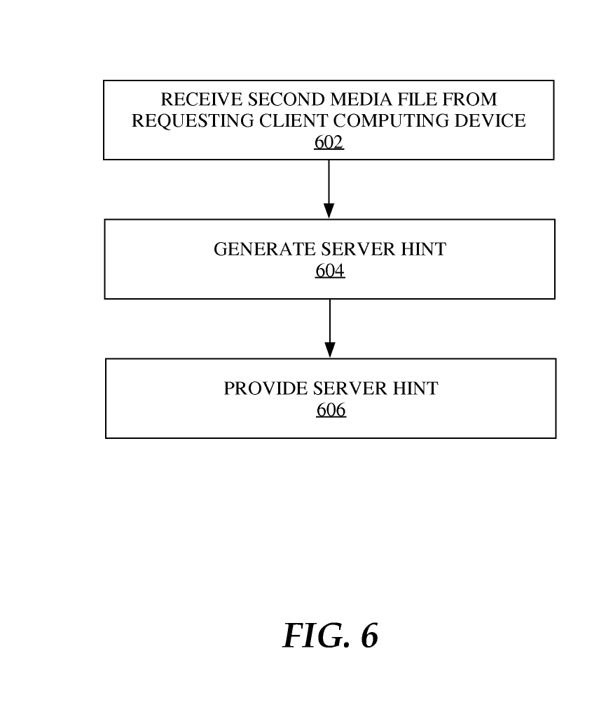

For illustration purposes, an example of server hint generation is provided in FIG. 6. FIG. 6 is a flow diagram that illustrates an embodiment of a method for processing a second media file received from a client in response to viewing a first media file. In one embodiment, the method is performed after a first media file is provided to a client computing device, such as by the method shown in FIG. 5.

At step 602, a second media file is received from a client computing device in a second encoding format after a first media file is displayed on the client computing device. The second encoding format may be the same as or different from an initial encoding format of the first media file. In one embodiment, the client computing device is configured to display media files and generate media files in a configured format of the client computing device, such as when an operating system and/or an application of the client computing device is configured to display and generate media files in the configured format. In one embodiment, the second media file is received by the content delivery network, such as by an edge server computer of the content delivery network. The second media file may be received directly from the client computing device or indirectly via one or more other computing devices, such as via an application server computer.

In one embodiment, the application server computer is configured to implement a dating system, a professional development system, an interviewing system, or any other type of networking system. The first media file may be published by a first publisher seeking responses within the networking system. In one embodiment, the first publisher is seeking other entities, such individuals or entities interested in a date, a job, or another networking opportunity.

At step 604, a second server hint is generated by the application server computer. The server hint is associated with the second media file. When the client computing device submits a second media file in response to a first media file, the application server computer may be able to determine potential viewers of the second media file. For example, potential viewers may be determined based on an identity of the publisher of the first media file, an identity of the publisher of the second media file, a demographic associated with the publisher of the first media file, a demographic associated with the publisher of the second media file, a geographic location of the publisher of the first media file, a geographic location of the publisher of the second media file, and/or any other useful information related to potential viewing of the second media file.

In one embodiment, the server hint identifies a computing device associated with the publisher of the first media file, such as when the publisher of the first media file may be potential viewer of the second media file. The publisher of a media file may refer to a client computing device used to submit the media file, an entity associated with the client computing device used to submit the media file, and/or another client computing device associated with such an entity.

In one embodiment, the application server computer may determine that the first publisher is likely to view the second media file submitted in response to the first media file. The application server computer may perform one or more evaluations of the second media file and/or a publisher associated with the second media file to determine whether the first publisher is likely to view the second media file. For example, the application server computer may screen profile information associated with the publisher of the second media file.

At step 606, the second server hint is provided to the content delivery network by the application server computer. The second server hint may be processed in accordance with one or more embodiments described herein, such as any portion of the method described in FIG. 4.

10. Example Content Delivery System for Interview Content

Additional examples of server hint generation are provided in this section with respect to a content delivery system configured to store multimedia interview content, for example, for employment interviews of candidates for positions at businesses or other institutions. The content delivery system may interface with an application server computer that is configured to provide on-line remote interview services. The content delivery system may be configured to store interview media provided by an interviewer, practice interview media, recruiting media, interview response media provided by a candidate, or any combination thereof.

For example, server hints may be generated based on usage patterns. Usage patterns may be analyzed based on an individual, all users of a specific type (e.g. candidates), or a group of users of a specific type (e.g. engineering candidates, interviewers located in North America, etc.). Usage patterns may include timing information, actions performed, resources accessed, and any other usage pattern that may be obtained for one or more users. For example, if usage patterns indicate that the majority of the candidates who complete a practice interview, will choose to begin an actual interview in the near future, a server hint may be generated for interview media after a candidate completes or nearly completes a practice interview.

Another example is generating server hints based on context. For example, when a recruiter invites one or more candidates to submit a response to a specific interview, it is reasonable to assume that the recruiter will review those responses fron the invited candidates. As another example, when a first user shares media with a second user with whom the first user has an existing relationship, it may be reasonable to assume that the second user will review the media. The existing relationship may be between two users in the same organization, a hiring manager and a recruiter, a recruiter and a hiring client or candidate client, or any other relationship. In these instances, one or more server hints may be generated accordingly.

Another example is generating server hints based on defined policies. For example, some employers may designate that their employee users can only access media resources from authorized devices, such as work computers, work-issued mobile devices, or any other restricted set of authorized devices. In this case, information known about these authorized devices may be used to generate server hints. For example, the authorized devices may share a common operating system that is compatible with a specific file format.

11. Implementation Mechanisms—Hardware Overview

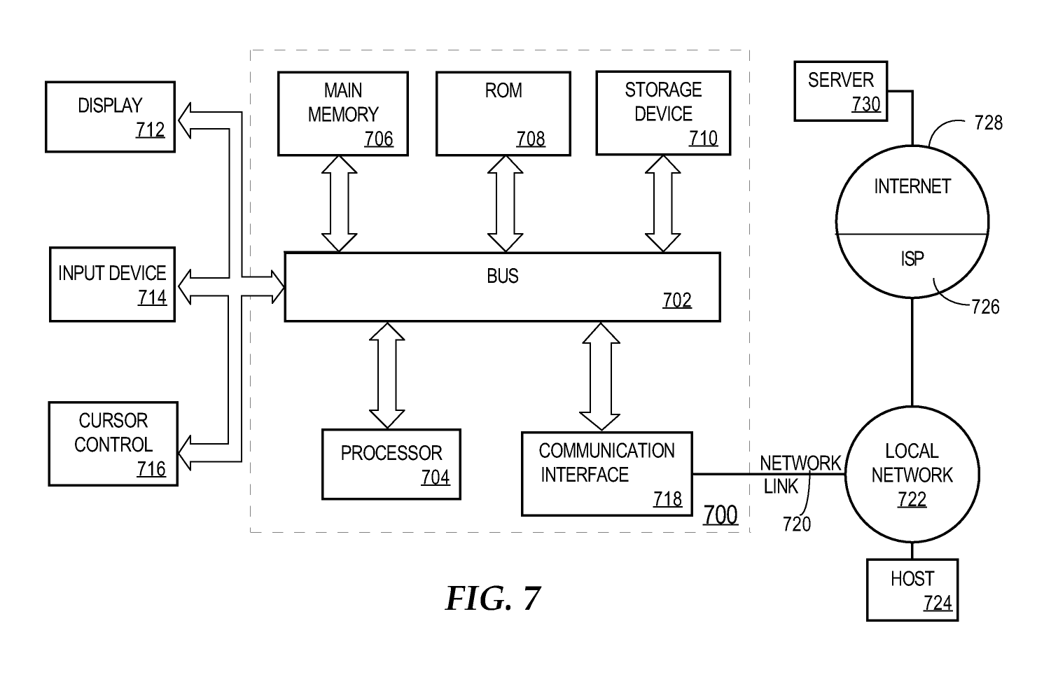

FIG. 7 is a block diagram that illustrates a computer system 700 upon which an embodiment of the invention may be implemented. Computer system 700 includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

The invention is related to the use of computer system 700 for implementing the techniques described herein. According to one embodiment of the invention, those techniques are performed by computer system 700 in response to processor 704 executing one or more sequences of one or more instructions contained in main memory 706. Such instructions may be read into main memory 706 from another machine-readable medium, such as storage device 710. Execution of the sequences of instructions contained in main memory 706 causes processor 704 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 700, various machine-readable media are involved, for example, in providing instructions to processor 704 for execution. Such a medium may take many forms, including but not limited to storage media and transmission media. Storage media includes both non-volatile media and volatile media. Non-volatile media includes, for example, optical or magnetic disks, such as storage device 710. Volatile media includes dynamic memory, such as main memory 706. Transmission media includes coaxial cables, copper wire and fiber optics, including the wires that comprise bus 702. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are exemplary forms of carrier waves transporting the information.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution. In this manner, computer system 700 may obtain application code in the form of a carrier wave.

11. Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
receiving client attribute data for a selected client computing device, the client attribute data comprising a selected encoding format;
receiving, by a content delivery network comprising a plurality of edge server computers, a server hint indicating that the selected client computing device is likely to access a first media file;
receiving, by a first edge server computer of the content delivery network, the first media file in a first encoding format;
calculating, by the content delivery network, at least one cost value associated with propagating the first media file in the content delivery network based on the client attribute data;
determining, by the content delivery network, whether to transmit the first media file to a selected edge server computer of the content delivery network based on the at least one cost value;
transcoding, by the content delivery network, the first media file from the first encoding format to the selected encoding format when the selected encoding format is different from the first encoding format;
transmitting the first media file to the selected edge server computer;
storing, by the selected edge server computer, the first media file in the selected encoding format;
wherein the method is performed by one or more computing devices.

2. The method of claim 1, wherein calculating the at least one cost value, determining whether to transmit the first media file to the selected edge computer, transcoding the first media file, and transmitting the first media file to the selected edge server computer are performed by the first edge server computer.

3. The method of claim 1, wherein the client attribute data comprises at least one network metric associated with the client computing device.

4. The method of claim 3, further comprising:
determining, by the content delivery network, at least one bit rate based on the at least one network metric, wherein transcoding the first media file is based on the at least one bit rate.

5. The method of claim 1, wherein the client attribute data is received by an application server computer when the client computing device is connected to the application server computer.

6. The method of claim 5, wherein the server hint is generated by the application server computer based on the client attribute data.

7. The method of claim 5, wherein the server hint is based on an interaction between the selected client computing device and the application server computer.

8. The method of claim 7, wherein the interaction comprises accessing, on the application server computer, a notification that the first media file is available.

9. The method of claim 5, further comprising:
receiving from the selected client computing device, by the application server computer, a request for a resource comprising a first resource portion and the first media file;
providing to the selected client computing device, by the application server computer, the first resource portion and at least one network address associated with the selected edge server computer;
receiving from the requesting client computing device, by the selected edge server computer, a media request for the first media file;
providing to the selected client computing device, by the particular edge server computer, the first media file in the selected encoding format.

10. The method of claim 5, further comprising:
receiving, from the selected client computing device, a second media file in a second encoding format after the first media file is displayed on the requesting client computing device;
generating, by the application server computer, a second server hint associated with the second media file;
providing, by the application server computer, the second client hint to the content delivery network.

11. The method of claim 10, wherein the second server hint identifies a computing device associated with a publisher of the first media file as a potential viewer of the second media file.

12. A non-transitory computer-readable medium carrying one or more sequences of instructions, which, when executed by one or more processors, cause the one or more processors to carry out the steps of:
receiving client attribute data for a selected client computing device, the client attribute data comprising a selected client encoding format;
receiving, by a content delivery network comprising a plurality of edge server computers, a server hint indicating that the selected client computing device is likely to access a first media file;
receiving, by a first edge server computer of the content delivery network, the first media file in a first encoding format;
calculating, by the content delivery network, at least one cost value associated with propagating the first media file in the content delivery network based on the client attribute data;
determining, by the content delivery network, whether to make the first media file available in the selected encoding format on a selected edge server computer of the content delivery network based on the at least one cost value;
transcoding, by the content delivery network, the first media file from the first encoding format to selected encoding format when the selected encoding format is different from the first encoding format;
transmitting the first media file to the selected edge server computer;
storing, by the selected edge server computer, the first media file in the selected encoding format.

13. The non-transitory computer-readable medium of claim 12, wherein calculating the at least one cost value, determining whether to transmit the first media file to the selected edge computer, transcoding the first media file, and transmitting the first media file to the selected edge server computer are performed by the first edge server computer.

14. The non-transitory computer-readable medium of claim 12, wherein the client attribute data comprises at least one network metric associated with the client computing device.

15. The non-transitory computer-readable medium of claim 14, the steps further comprising:
determining, by the content delivery network, at least one bit rate based on the at least one network metric, wherein transcoding the first media file is based on the at least one bit rate.

16. The non-transitory computer-readable medium of claim 12, wherein the client attribute data is received by an application server computer when the client computing device is connected to the application server computer.

17. The non-transitory computer-readable medium of claim 16, wherein the server hint is generated by the application server computer based on the client attribute data.

18. The non-transitory computer-readable medium of claim 16, wherein the server hint is based on an interaction between the at selected client computing device and the application server computer.

19. The non-transitory computer-readable medium of claim 18, wherein the interaction comprises accessing, on the application server computer, a notification that the first media file is available.

20. The non-transitory computer-readable medium of claim 16, the steps further comprising:
receiving from the selected client computing device, by the application server computer, a request for a resource comprising a first resource portion and the first media file;
providing to the selected client computing device, by the application server computer, the first resource portion and at least one network address associated with the selected edge server computer;
receiving from the requesting client computing device, by the selected edge server computer, a media request for the first media file;
providing to the selected client computing device, by the particular edge server computer, the first media file in the selected encoding format.

21. The non-transitory computer-readable medium of claim 16, the steps further comprising:
receiving, from the selected client computing device, a second media file in a second encoding format after the first media file is displayed on the requesting client computing device;
generating, by the application server computer, a second server hint associated with the second media file;
providing, by the application server computer, the second client hint to the content delivery network.

22. The non-transitory computer-readable medium of claim 21, wherein the second server hint identifies a computing device associated with a publisher of the first media file as a potential viewer of the second media file.
